(19) United States
(12) Patent Application Publication
(10) Pub. No.: US 2015/0252883 A1
(43) Pub. Date: Sep. 10, 2015

(54) RADIAL SPLIT STATOR

(71) Applicant: Schaeffler Technologies AG & Co. KG, Herzogenaurach (DE)

(72) Inventor: Jeremy Jewell, Wooster, OH (US)

(21) Appl. No.: 14/628,466

(22) Filed: Feb. 23, 2015

Related U.S. Application Data
(60) Provisional application No. 61/948,986, filed on Mar. 6, 2014.

(51) Int. Cl. F16H 41/24

(52) U.S. Cl. CPC F16H 41/24

(57) ABSTRACT

A torque converter having an input means and an output means comprising a cover non-rotatably connected to the input means, an impeller having an impeller shell non-rotatably connected to the cover, the impeller having at least one blade fixedly secured to the impeller shell, a turbine having a turbine shell non-rotatably connected to the output means, the turbine having at least one blade fixedly secured to the turbine shell, and, a stator having an inner circumferential wall, an outer circumferential wall, and a splitter operatively arranged between the inner circumferential wall and the outer circumferential wall, the stator comprising a first radial section having at least one blade fixedly secured to the splitter and extending radially outward towards the outer circumferential wall, and, a second radial section arranged concentrically within the first radial section, the second radial section comprising at least one blade fixedly secured to the inner circumferential wall and extending radially towards the splitter.

### CROSS-REFERENCE TO RELATED APPLICATIONS

This application claims the benefit under 35 U.S.C. §119(e) of U.S. Provisional Patent Application No. 61/948,986, filed Mar. 6, 2014, which application is incorporated herein by reference in its entirety.

### FIELD OF THE INVENTION

The invention relates generally to a torque converter and, more specifically, to a radial split stator of a torque converter.

### BACKGROUND OF THE INVENTION

A torque converter is used to transfer torque from an engine to a transmission in a motor vehicle. The torque converter includes a turbine having an impeller and a turbine, which are engaged by a fluid, so that the rotating impeller drives the turbine. To minimize power losses at high rotational speeds, a clutch is also provided, in order to engage the rotation of the turbine wheel to the impeller when needed. The transfer of torque takes place during acceleration of the motor vehicle through the hydrodynamic coupling of the turbine with the impeller, and during normal driving operation through the mechanical coupling of the clutch.

In order for a torque converter to function, a stator must be positioned between the turbine and impeller. The stator comprises a series of blades that are positioned in the flow path of the fluid returning to the impeller from the turbine. The purpose of the stator is to redirect the fluid returning to the impeller from the turbine in order to multiply the torque output of the torque converter. The stator has a single blade profile which requires a smooth transition from the huh of the stator to the shroud of the stator, limiting the extent to which the blade profile can be altered. In addition, a single blade profile requires that the same amount of blades be used throughout the entire flow path within the stator. Due to this limitation, the stator blades cannot redirect the fluid in the most effective way back to the impeller due to the blade profile of the stator having to transition smoothly.

FIG. 5B is an enlarged cross-sectional view of traditional stator 170 with fluid 160 flowing through stator 170. As seen by the figure, fluid 160 only has one fluid path to flow through. Blades 174 are fixedly secured between hub 171 and shroud 172 to form the flow path. In this configuration, fluid 160 has no choice but to flow over blades 174 at any rotational speed. Therefore, torque is either not maximized at low rotational speeds or energy is being wasted at high rotational speeds since the blade profile of blades 174 must be continuous from hub 171 to shroud 172 and only one of the applications can be chosen for stator 170 to embody.

U.S. Pat. No. 8,202,052 (Brees et al.) discloses a three-part stator blade where a middle segment is circumferentially and axially disposed between a first and third segment. Further, the segments that compose the stator blade are circumferentially and axially off-set. Brees et al, fail to disclose or teach, however, a stator that most efficiently redirects the fluid back to the impeller at any rotational speed.

Thus, there exists a long felt need for a stator with a radial splitter creating two individual stator blade profiles.

### BRIEF SUMMARY OF THE INVENTION

The present invention broadly includes a torque converter having an input means and an output means comprising a cover non-rotatably connected to the input means, an impeller having an impeller shell non-rotatably connected to the cover, the impeller also having at least one blade fixedly secured to the impeller shell, a turbine having a turbine shell non-rotatably connected to the output means, the turbine also having at least one blade fixedly secured to the turbine shell, and, a stator having an inner circumferential wall, an outer circumferential wall, and a splitter operatively arranged between the inner circumferential wall and the outer circumferential wall, the stator comprising a first radial section having at least one blade fixedly secured to the splitter and extending radially outward towards the outer circumferential wall, and, a second radial section arranged concentrically within the first radial section, the second radial section comprising at least one blade fixedly secured to the inner circumferential wall and extending radially towards the splitter.

The invention also comprises a stator having an inner circumferential wall, an outer circumferential wall, and a splitter operatively arranged between the inner circumferential wall and outer circumferential wall comprising a first radial section having at least one blade fixedly secured to the splitter and extending radially outward towards the outer circumferential wall, and, a second radial section arranged concentrically within the first radial section, the second radial section comprising at least one blade fixedly secured to the inner circumferential wall and extending radially towards the splitter.

A general object of the invention is to provide a torque converter which performs the same function as prior torque converters but maximizes the efficiency of the hydrodynamic coupling between the turbine and impeller.

These and other objects, features and advantages of the present invention will become readily apparent upon a reading and review of the following detailed description of the invention, in view of the appended drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a partial cross-sectional view of a torque transmission apparatus including a radial split stator;

FIG. 3 is a perspective view of a radial split stator comprising two radial sections;

FIG. 4 is a front view of the radial split stator shown in FIG. 3;

FIG. 5A is an enlarged, partial cross-sectional view of the radial split stator taken generally along line 5A-5A in FIG. 4; and,

FIG. 5B is an enlarged, partial cross-sectional view of a traditional stator similar to the view of FIG. 5A.

### DETAILED DESCRIPTION OF THE INVENTION

At the outset, it should be appreciated that like drawing numbers on different drawing views identify identical, or functionally similar, structural elements of the invention. It is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention as claimed.

Unless defined otherwise, all technical and scientific terms used herein have the same meaning as commonly understood to one of ordinary skill in the art to which this invention pertains. It should be understood that any methods, devices or materials similar or equivalent to those described herein can be used in the practice or testing of the invention.

By “non-rotatably connected” first and second components we mean that the first component is connected to the second component so that any time the first component rotates, the second component rotates with the first component, and any time the second component rotates, the first component rotates with the second component. Axial displacement between the first and second components is possible.

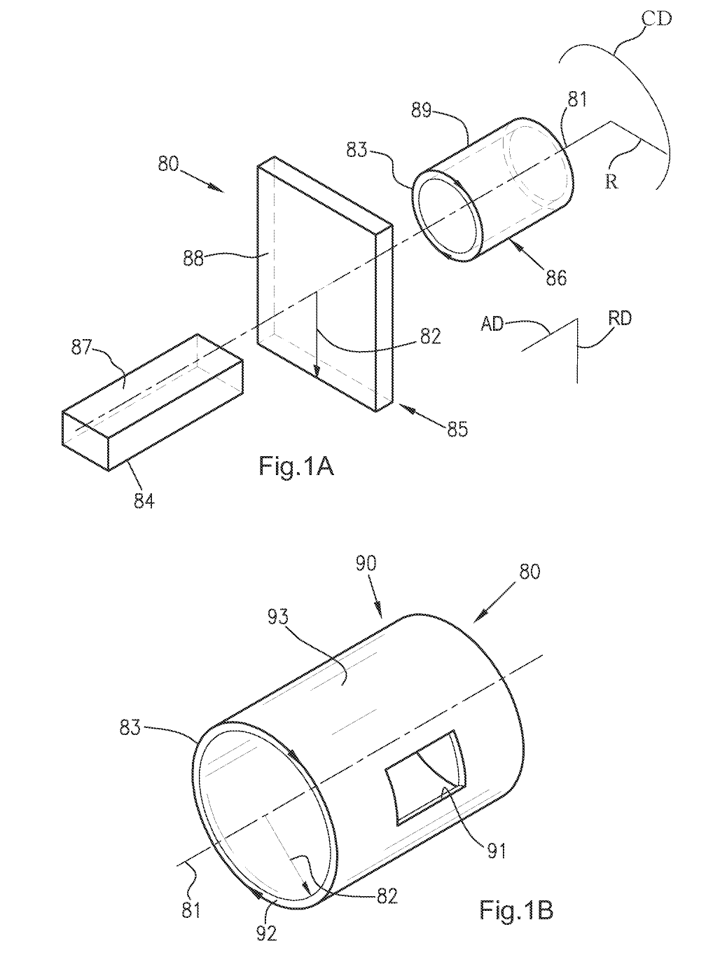

FIG. 1A is a perspective view of cylindrical coordinate system 80 demonstrating spatial terminology used in the present patent. The present invention is at least partially described within the context of a cylindrical coordinate system 80. System 80 has a longitudinal axis 81, used as the reference for the directional and spatial terms that follow. Axial direction AD is parallel to axis 81. Radial direction RD is orthogonal to axis 81. Circumferential direction CD is defined by an endpoint of radius R (orthogonal to axis 81) rotated about axis 81.

To clarify the spatial terminology, objects 84, 85, and 86 are used. Surface 87 of object 84 forms an axial plane. For example, axis 81 is congruent with surface 87. Surface 88 of object 85 forms a radial plane. For example, radius 82 is congruent with surface 88. Surface 89 of object 86 forms a circumferential surface. For example, circumference 83 is congruent with surface 89. As a further example, axial movement or disposition is parallel to axis 81, radial movement or disposition is orthogonal to axis 82, and circumferential movement or disposition is parallel to circumference 83. Rotation is described herein with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” are used with respect to an orientation parallel to respective planes.

FIG. 1B is a perspective view of object 90 in cylindrical coordinate system 80 of FIG. 1A demonstrating spatial terminology used in the present patent. Cylindrical object 90 is representative of a cylindrical object in a cylindrical coordinate system and is not intended to limit the claims of the present invention in any manner. Object 90 includes axial surface 91, radial surface 92, and circumferential surface 93. Surface 91 is part of an axial plane; surface 92 is part of a radial plane, and surface 93 is part of a circumferential plane.

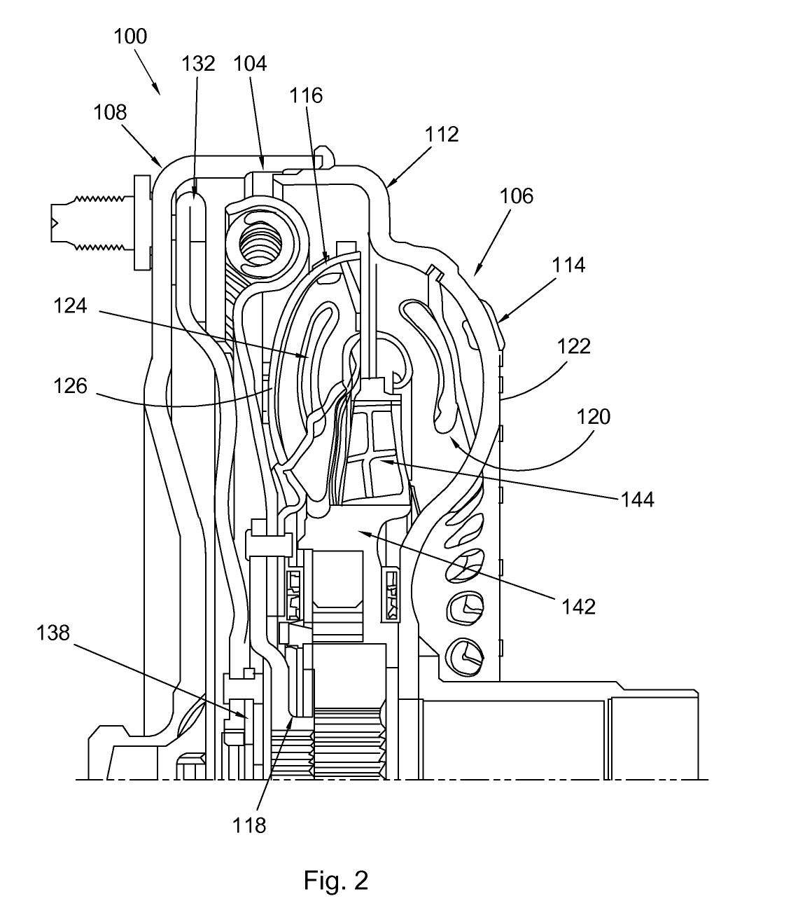

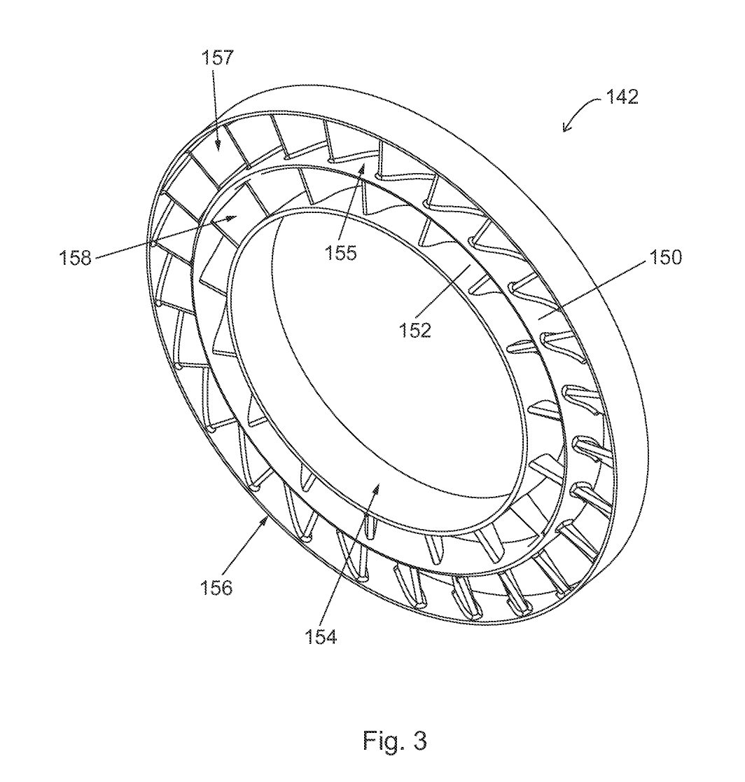

FIG. 2 is a partial cross-sectional view of torque transmission apparatus 100. Apparatus 100 includes vibration damper 104 and torque converter 106. Damper 104 includes cover 108 arranged to receive torque from an engine. Torque converter 106 includes cover 112 non-rotatably connected to cover 108, impeller 114, turbine 116, and output hub 118. Impeller 114 includes at least one blade 120 and impeller shell 122 is non-rotatably connected to cover 108. Turbine 116 includes at least one blade 124 and turbine shell 126. Stator 142 comprises first radial section 150 and second radial section 152 operatively arranged between impeller 114 and turbine 116 (shown in FIG. 3). Stator 142 influences the flow of fluid passing from turbine 116 to impeller 114, increasing the force that the fluid applies to blade 120 which is fixedly secured to impeller shell 122.

In an example embodiment, torque converter 106 includes torque converter clutch 132. At low rotational speeds, when torque multiplication is needed, clutch 132 does not engage cover 112 and hub 138 is limitedly rotatable with respect to impeller shell 122. At high rotational speeds, though, when the rotational speed of turbine 116 is almost that of impeller 114, clutch 132 engages cover 108, which allows for a direct connection between the engine and the transmission for torque transfer. When clutch 132 engages cover 108, hub 138 non-rotatably connects to cover 108 via clutch 132.

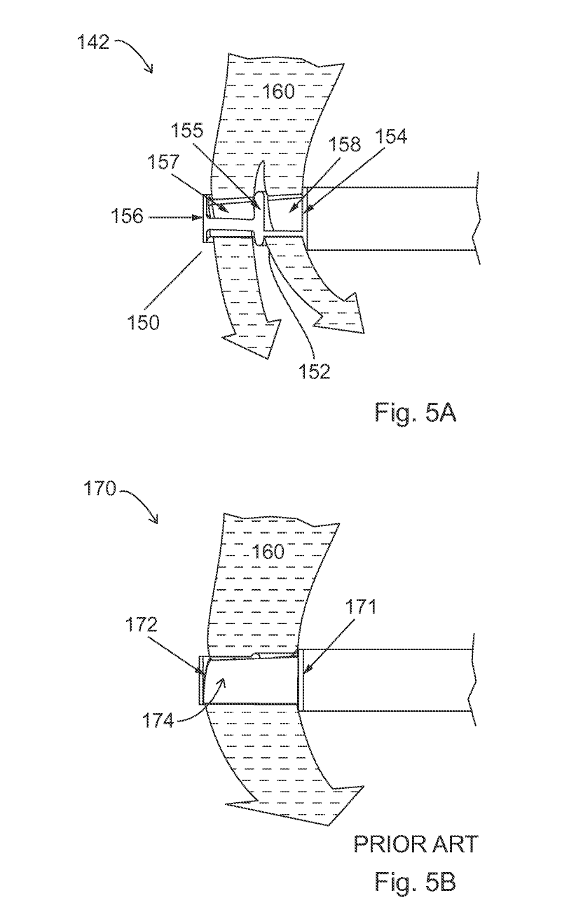

FIG. 3 is a perspective view of stator 142, which comprises hub 154, splitter 155, and shroud 156. First radial section 150 is located between splitter 155 and shroud 156 and has at least one blade 157 fixedly secured between splitter 155 and shroud 156. Second radial section 152 is concentrically arranged within first radial section 150. Second radial section 152 is located between hub 154 and splitter 155 and has at least one blade 158 fixedly secured between hub 154 and splitter 155. Hub 154 is used as a mounting point for a one-way clutch device (not shown) to allow for torque multiplication within torque converter 106 while the vehicle is accelerating. Blade 157 and blade 158 each have a different blade profile to allow for a greater change in the direction of fluid flow while torque converter 106 is in operation. Both first radial section 150 and second radial section 152 have a unique blade profile and blade count, which differ from a traditional stator which must have a blade profile that transitions smoothly from hub 171 to shroud 172 (shown in FIG. 5B), Splitter 155 acts as a divider within stator 142 between first radial section 150 and second radial section 152.

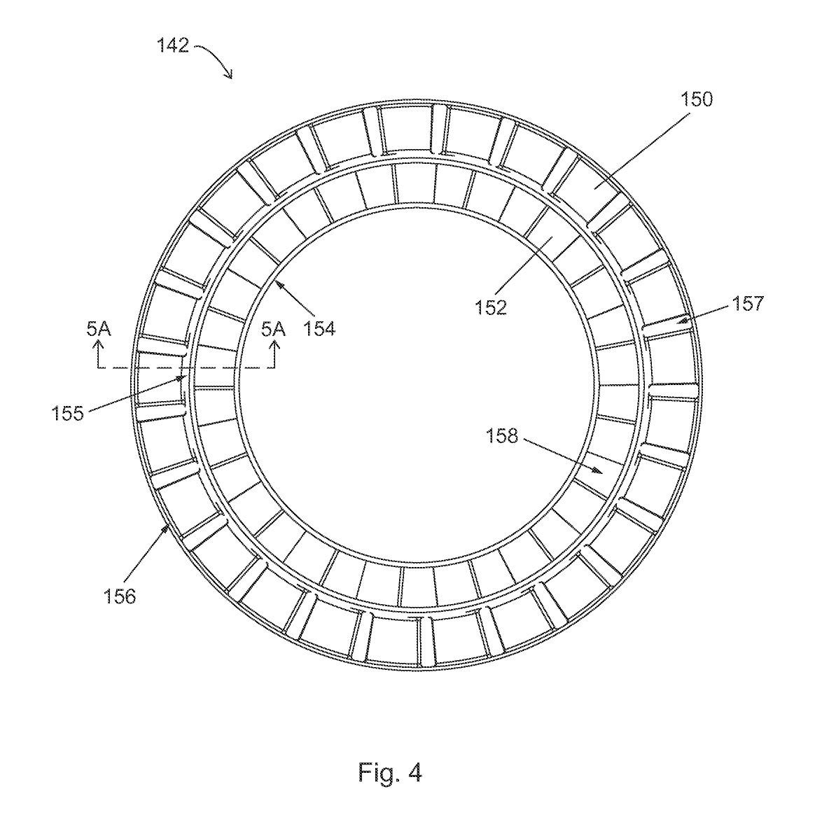

In order to achieve maximum performance of torque converter 106, first radial section 150 and second radial section 152 can include a different number of blades 157 and blades 158 as seen in FIG. 4. Second radial section 152 comprises a greater turning angle and a fewer number of blades 158 relative to first radial section 150 and blades 157. In an example embodiment, first radial section 150 and second radial section 152 are cast separately and then fit together using a friction fit to prevent unwanted rotation of one radial section relative to the other. It should be appreciated, however, that other manufacturing methods are possible and considered to be within the scope of the invention as claimed. For example, stator 142 can be cast from a single mold creating a single piece, or stator 142 can be milled from a single piece of manufacturing material.

The flow of fluid 160 through stator 142 is shown in FIG. 5A. As fluid 160 is returning to impeller 114 from turbine 116, fluid 160 impacts blades 157 and blades 158. Fluid 160 splits into two separate flow paths due to the arrangement of splitter 155. Each flow path enters either first radial section 150 or second radial section 152. Due to the different blade profile of blades 157 and blades 158, the two separate flow paths of fluid 160 exit first radial section 150 and second radial section 152 with different flow rates and angles of deflection. These differences in flow rates and angles of deflection maximize the performance of torque converter 106 in certain applications.

At low rotational speeds, a majority of fluid 160 will flow through second radial section 152 due to a lack of rotational forces to push fluid 160 to the outside of the stator. Due to this, second radial section 152 has fewer blades 158 but each with a greater turning angle. This configuration is optimal for maximizing torque at low rotational speeds. At high rotational speeds, a majority of fluid 160 flows through first radial section 150 of stator 142. Within first radial section 150, there are a greater number of blades 157 and at a lessened turning angle relative to second radial section 152. The configuration of first radial section 150 is to ensure torque does not multiply at high rotational speeds, which would waste energy in torque converter 106. It can now be seen that the bifurcated flow of fluid enabled by radial split stator 142 as indicated is superior to that of the flow of fluid enabled by traditional stator 170 as described the background supra.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMBERS

80 system
81 longitudinal axis
82 radius
83 circumference
84 object
85 object
86 object
87 surface
88 surface
89 surface
90 object
91 axial surface
92 radial surface
93 surface
100 torque transmission apparatus
104 damper
106 torque converter
108 cover
112 cover
114 impeller
116 turbine
118 output hub
120 blades
122 impeller shell
124 blades
126 turbine shell
132 clutch.
138 hub
142 stator
150 first radial section
152 second radial section
154 hub
155 splitter
156 shroud
157 blades
158 blades
160 fluid
170 traditional stator
171 hub
172 shroud
174 blades

What I claim is:

1. A torque converter having an input means and an output means, comprising:
a cover non-rotatably connected to said input means;
an impeller having an impeller shell non-rotatably connected to said cover, said impeller also having at least one blade fixedly secured to said impeller shell;
a turbine having a turbine shell non-rotatably connected to said output means, said turbine also having at least one blade fixedly secured to said turbine shell; and,
a stator having an inner circumferential wall, an outer circumferential wall, and a splitter operatively arranged between said inner circumferential wall and said outer circumferential wall, said stator comprising:
a first radial section having at least one blade fixedly secured to said splitter and extending radially outward towards said outer circumferential wall; and,
a second radial section arranged concentrically within said first radial section, said second radial section comprising at least one blade fixedly secured to said inner circumferential wall and extending radially towards said splitter.

2. The torque converter recited in claim 1, wherein said stator is formed from two separate castings.

3. The torque converter recited in claim 2, wherein said two separate castings are concentrically arranged.

4. The torque converter recited in claim 1, wherein said first radial section and said second radial section have the same blade profile.

5. The torque converter recited in claim 4, wherein said blade profile is continuous through said splitter.

6. The torque converter recited in claim 1, wherein said splitter is equidistant between said outer circumferential wall and said inner circumferential wall.

7. The torque converter recited in claim 1, wherein said splitter is perpendicular to said output means.

8. The torque converter recited in claim 1, wherein said stator specifically corresponds with said turbine.

9. The torque converter recited in claim 1, wherein said stator specifically corresponds with said impeller.

10. A torque converter having an input means and an output means, comprising:
a cover non-rotatably connected to said input means;
an impeller having an impeller shell non-rotatably connected to said cover, said impeller also having at least one blade fixedly secured to said impeller shell;
a turbine having a turbine shell non-rotatably connected to said output means, said turbine also having at least one blade fixedly secured to said turbine shell; and,
a stator having an inner circumferential wall, an outer circumferential wall, and a splitter operatively arranged between said inner circumferential wall and said outer circumferential wall, said stator comprising:
a first radial section having at least one blade fixedly secured to said splitter and extending radially outward towards said outer circumferential wall; and,
a second radial section arranged concentrically within said first radial section, said second radial section comprising at least one blade, in a different number than said blades fixedly secured in said first radial section, fixedly secured to said inner circumferential wall and extending radially towards said splitter.

11. The torque converter recited in claim 10, wherein said stator, said turbine, and said impeller are axially aligned.

12. The torque converter recited in claim 10, wherein said first radial section has a higher blade count than said second radial section.

13. The torque converter recited in claim 10, wherein said blades in said first radial section and said blades in said second radial section comprise of the same blade profile.

14. The torque converter recited in claim 10, wherein said stator engages said impeller said turbine via a fluid.

15. A torque converter having an input means and an output means, comprising:
a cover non-rotatably connected to said input means;
an impeller having an impeller shell non-rotatably connected to said cover, said impeller also having at least one blade fixedly secured to said impeller shell;
a turbine having a turbine shell non-rotatably connected to said output means, said turbine also having at least one blade fixedly secured to said turbine shell; and,
a stator having an inner circumferential wall, an outer circumferential wall, and a splitter operatively arranged between said inner circumferential wall and said outer circumferential wall, said stator comprising:
a first radial section having at least one blade of a first blade profile fixedly secured to said splitter and extending radially outward towards said outer circumferential wall; and,
a second radial section arranged concentrically within said first radial section, said second radial section comprising at least one blade of a second blade profile fixedly secured to said inner circumferential wall and extending radially towards said splitter.

16. The torque converter recited in claim 15, wherein said first blade profile is substantially different from said second blade profile.

17. The torque converter recited in claim 16, wherein said second blade profile has a greater turning angle.

18. The torque converter recited in claim 15, wherein said stator is mounted axially via a one-way clutch.

19. The torque converter recited in claim 15, wherein stator will rotate in the same rotational direction as said turbine and said impeller at high rotational speeds.

20. The torque converter recited in claim 15, wherein said first radial section and said second radial section are concentrically arranged by a friction fit.
